(19) United States
(12) Patent Application Publication
(10) Pub. No.: US 2017/0195172 A1
(43) Pub. Date: Jul. 6, 2017

(54) ASSEMBLY OF ELECTRONIC DEVICES INTENDED TO BE CONNECTED TO AT LEAST ONE COMPUTER NETWORK AND METHOD OF TRANSFERRING DIGITAL DATA IN THIS ASSEMBLY

(71) Applicant: DEVIALET, Paris (FR)

(72) Inventors: Charles COQUERET, Paris (FR); Pierre-Emmanuel CALMEL, Le Chesnay (FR)

(73) Assignee: DEVIALET, Paris (FR)

(21) Appl. No.: 15/310,507

(22) PCT Filed: Apr. 14, 2015
(86) PCT No.: PCT/EP2015/058073

§ 371 Date: Nov. 11, 2016

(30) Foreign Application Priority Data
Apr. 15, 2014 (FR) 14 53376

(51) Int. Cl. H04L 12/24; H04B 3/54; H04W 4/00

(52) U.S. Cl. CPC H04L 41/0803; H04W 4/008; H04B 3/54; H04W 84/12

(57) ABSTRACT

An assembly of electronic devices connected to a computer network comprises a digital data sender device comprising a short-range radioelectric main communication module and a secondary communication module, and a digital data receiver device comprising a short-range radioelectric main communication module and a secondary communication module. The assembly furthermore comprises a digital data transmitter device comprising a processor, a memory for storing the digital data, and a short-range radioelectric communication module able to communicate with the secondary module of the sender device when the transmitter device is in proximity to the sender device, and with the secondary module of the receiver device when the transmitter device is in proximity in the receiver device.

### CROSS-REFERENCE TO RELATED APPLICATIONS

This application is a National Stage of International Application No. PCT/EP2015/058073, filed Apr. 14, 2015. This application, in turn, claims priority to French Patent Application No. 1453376, filed Apr. 15, 2014. Both applications are incorporated herein by reference.

### FIELD OF THE INVENTION

The present invention relates to an assembly of electronic devices intended to be connected to at least one computer network, of the type including a device for transmitting digital data comprising a main communication module with the computer network and a secondary short range radioelectric communication module, the transmitter device being able to generate digital data; and at least one device for receiving digital data comprising a main communication module with the computer network and a secondary short range radioelectric communication module, the receiver device being able to use the digital data generated by the transmitter device.

The present invention also relates to also a method for transferring digital data in this assembly.

Such a computer network is generally a wireless computer network for example based on a protocol compliant with the IEEE 802.11 standard or a wired network for example based on a protocol of the Ethernet or PLC (acronym of “program line communication”) type.

The method for transferring digital data is for example a method for establishing a secured connection to the computer network in the whole of the electronic devices. In this case, the digital data comprise data for configuring the network giving the possibility of establishing such a connection.

### BACKGROUND

In the state of the art, there exist various systems and/or computer methods giving the possibility of simplifying the phase for establishing a secured connection of an electronic device to a computer network.

This is notably the case of wireless computer networks based on a protocol compliant with the IEEE 802.11 standard and of “smart” electronic devices requiring particular configurations for accessing these networks very safely.

Thus, for example, the protocol WPS (“Wi-Fi Protected Setup”) allows a user having little knowledge on computer security of rapidly configuring an electronic device so that the latter may be connected to the network via predetermined point of access.

More particularly, this protocol proposes a method in which the user pushes on a physical or virtual button, both on the point of access and on the electronic device. This gives the possibility of removing the security of the computer network during a short instant so that the electronic device may receive in “free access” configuration data required for establishing a permanent connection with the network.

A similar method also exist for wired networks of the PLC type and consist of pressing simultaneously on buttons provided for this purpose on each end of the network.

A major fault of this method lies in the impossibility of securing the network when both buttons are pressed, and the configuration data are then in <<free access>>. Thus, these configuration data may be transmitted to any other electronic device covered by this network and being able to receive these data.

The WPS protocol further proposes a method based on near field communication technology (NFC) giving the possibility to the user of physically approaching the electronic device of the point of access in order to be able to configure the electronic device by exchanging configuration data of the network in the near field of the point of access.

However, this solution is not completely satisfactory. In particular, the connection method based on the NFC technology does not allow fast configuration of two electronic devices physically positioned in different locations and being possibly cumbersome, or more than two devices. Further, as this technology may be in majority applied to wireless networks compliant with the IEEE 802.11 standard, remains difficult to adapt to other types of networks, including wired networks of the PLC type.

### SUMMARY

The object of the present invention is to propose an assembly of electronic devices and a method for transferring digital data in this assembly giving the possibility of rapidly and easily establishing a secured connection between a point of access and a plurality of potentially cumbersome electronic devices and this independently of the type of network connecting them.

For this purpose, the object of the invention is an assembly of electronic devices, further including a portable device for transmitting digital data and comprising a processor; a memory capable of storing the digital data and at least one piece of software for controlling the transmitting device, executed by said processor;

a unique short range radioelectric communication module capable of communicating with the secondary communication module of the transmitter device for recovering the digital data generated by the transmitter device in order to store them in said memory when the transmitter device is in proximity to the emitting device, and with the secondary communication module of the receiver device for transmitting to the receiver device at least some of the digital data stored in said memory when the transmitter device is in proximity to the receiver device.

According to other advantageous aspects of the invention, the piece of equipment comprises one or several of the following features, taken individually or according to all the technically possible combinations:
the transmitter device further includes an electric power supply source of said processor, of said memory and of said communication module;
the unique communication module of the transmitter device and the secondary communication modules of the emitting device and of the receiver device are compatible with a communication protocol compliant with the IEEE 802.15.4 standard;
the unique communication module of the transmitter device is able to communicate with each of the secondary radioelectric communication modules of the emitting device and of the receiver device at a distance of less than 10 cm;
each of the unique communication module and of the secondary communication modules is able to define a coverage field in which this communication module is able to communicate with the other communication modules via radioelectric waves;
each of the emitting device and of the receiving device includes a contact area; and the unique communication module of the transmitter device is able to communicate with each of the secondary radioelectric communication modules of the emitting device and of the receiving device by being in contact with the contact area of the emitting device or of the receiving device;
the main communication modules of the emitting device and of the receiving device are compatible with a communication protocol compliant with the IEEE 802.11 standard;
the main communication modules of the emitting device and of the receiving device are compatible with a communication protocol of the PLC type;
the digital data generated by the emitting device comprise data for configuration of the computer network allowing the receiver device to establish a secured connection with the computer network; and
the emitting device is able to send digital data to the receiving device via the computer network; and the receiving device comprises an acoustic chamber able to emit sound waves from the digital data stemming from the emitting device and delivered by the computer network.

The object of the invention is also a method for transferring digital data in such an assembly of electronic devices comprising the following steps:
generating digital data with the emitting device;
recovering digital data with the transmitter device and storing them in the memory after bringing the transmitter device close to the emitting device carried out by a user;
recovering digital data with the receiving device after bringing the transmitter device closer to the receiving device, carried out by the user;
using digital data with the receiving device having received these digital data.

### BRIEF DESCRIPTION OF THE DRAWINGS

The invention will be better understood upon reading the description which follows, exclusively given as an example and made with reference to the appended drawings, wherein:

FIG. 1 is a schematic view of an assembly of electronic devices according to the invention, the assembly including a transmitter device; and

FIG. 2 is a schematic view of the transmitter device of the assembly of electronic devices illustrated in FIG. 1.

### DETAILED DESCRIPTION

In the present description, by “short range” is for example meant any distance of less than 10 cm.

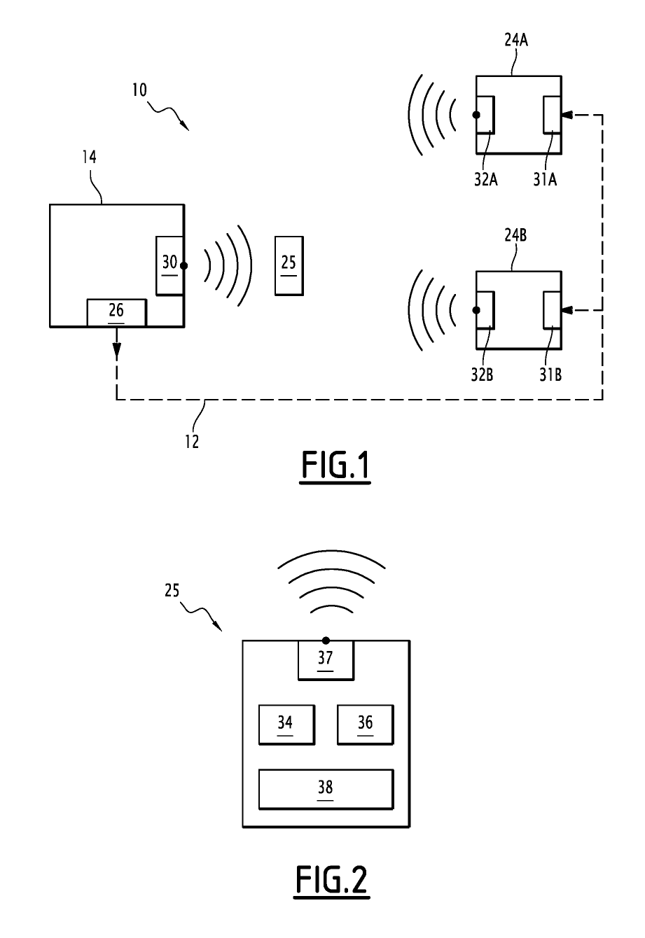

An assembly 10 of electronic devices is illustrated in FIG. 1.

The assembly 10 includes a plurality of electronic devices intended to be connected to a computer network 12.

The assembly 10 is for example an acoustic system.

The assembly 10 includes an emitting device 14 capable of generating digital data, two receiving devices 24A and 24B capable of using the digital data generated by the emitting device 14, and a transmitter device 25 giving the possibility of transmitting at least some of the digital data generated from the emitting device 14 to each of the devices 24A and 24B while avoiding the computer network 12.

The computer network 12 comprises a wired computer network known per se in the state of the art and able to transmit digital data between different electronic devices according to a suitable protocol.

The computer network 12 illustrated in FIG. 1 is a wired network compatible with a protocol of the PLC type (acronym of “program line communication”) and giving the possibility of transmitting digital data via electric cables which are part of a same electric power supply circuit. Such an electric power supply circuit is for example integrated in the home of a user.

According to another alternative embodiment, the computer network 12 is a wireless network compatible with a protocol of the IEEE 802.11 standard and giving the possibility of transmitting digital data as radioelectric waves.

According to further another alternative, the computer network 12 comprises several computer sub-networks of different types. Thus, for example, the computer network 12 comprises a wired sub-network of the PLC type and a wireless sub-network compliant with the IEEE 802.11 standard.

In all the other alternative embodiments, the computer network 12 is a secured network requiring identification for each connected electronic device. In other words, each electronic device connected to this network 12 is able to pass through a phase for establishing a secured connection to this network 12 in order to access it and to be able to send and/or receive digital data.

The operation of the computer network 12 is controlled by one of the electronic devices of the assembly 10.

The emitting device 14 is for example a server and/or a reader and/or an acoustic amplifier adapted for transmitting into the network 12 digital data associated with sound waves.

The emitting device 14 is further able to control the operation of the computer network 12 and in particular of generating digital data comprising configuration data allowing the other electronic devices of the assembly 10 to access the computer network 12.

The configuration data include for example the security data or one or more passwords giving access to the computer network 12.

The configuration data are able to be transmitted through the transmitter device 25 by avoiding the network 12 as this will be explained subsequently.

The emitting device 14 includes a main communication module 26 with the network 12, and a secondary short range radioelectric communication module 30.

The main communication module 26 gives the possibility to the emitting device 14 of emitting the digital data generated in the network 12 and optionally receive other digital data stemming from the network 12.

The secondary communication module 30 gives the possibility to the emitting device 14 of communicating with other electronic devices including a radioelectric communication module of the same type and found in a coverage field of the secondary communication module 30.

The secondary communication module 30 thus gives the possibility of emitting the digital data generated, in particular the configuration data, in its coverage field as radioelectric waves.

The secondary communication module 30 is able to define its coverage field.

According to an exemplary embodiment, in order to define its coverage field, the secondary communication module 30 is able to measure a power level of the radioelectric waves emitted by other communication modules in proximity to the secondary communication module 30 and to exclusively process the radioelectric waves with a power level greater than a predetermined threshold. Thus, this predetermined threshold defines the coverage field of the secondary communication module 30.

According to another exemplary embodiment, in order to define its coverage field, the secondary communication module 30 is able to emit radioelectric waves with a power level less than a predetermined threshold. Thus, this predetermined threshold defines the coverage field of the secondary communication module 30.

Of course, other methods for defining the coverage field according to the power of the received and/or emitted waves are also possible.

The coverage field of the secondary communication module 30 is for example limited by a sphere with a radius of less than 10 cm.

The secondary communication module 30 is compatible with a communication protocol based on the IEEE 802.15.4 standard and known per se in the state of the art.

Each receiver device 24A or 24B is for example a smart acoustic chamber able to emit sound waves from digital data generated by the emitting device 14 and received via the computer network 12.

Each receiving device 24A or 24B includes a main communication module 31A or 31B with the network 12 and a secondary short range radioelectric communication module 32A or 32B.

Each main communication module 31A or 31B gives the possibility to the corresponding receiving device 24A or 24B to receive via the network 12 the digital data generated by the emitting device 14 and optionally emitting other digital data into the network 12.

In a similar way to the secondary communication module 30 of the emitting device 14, each secondary communication module 32A or 32B allows radioelectric communication with a radioelectric communication module of the same type found in a coverage field of the secondary communication module 32A or 32B.

Each secondary communication module 32A or 32B notably gives the possibility of receiving some of the digital data, in particular configuration data generated by the emitting device 14 and transmitted by the transmitter device 25 as radioelectric waves.

Each secondary communication module 32A or 32B is able to define its coverage field according to one of the aforementioned methods and is compatible with a communication protocol based on the IEEE 802.15.4 standard.

The coverage field of each of the secondary communication modules 32A and 32B is for example limited by a sphere with a radius of less than 10 cm.

The transmitter device 25 is illustrated in more detail in FIG. 2.

In FIG. 2, the transmitter device 25 includes a processor 34, a memory 36, a unique short distance radioelectric communication module 37, and an electric power supply source 38.

The unique communication module 37 is a short range radioelectric communication module similar to each of the secondary communication modules 30, 32A or 32B described earlier.

Thus, the unique communication module 37 allows communication with other radioelectric communication modules of the same type found in its coverage field.

The unique communication module 37 notably gives the possibility of receiving some of the digital data, in particular the configuration data generated, and emitted by the emitting device 14 as radioelectric waves, and of emitting these digital data intended for each of the receiving devices 24A or 24B as radioelectric waves.

The unique communication module 37 is able to define its coverage field according to one of the aforementioned methods and is compatible with a communication protocol based on the IEEE 802.15.4 standard.

The coverage field of the unique communication module 37 is for example limited by a sphere with a radius of less than 10 cm.

The memory 36 is able to store the digital data, in particular the received configuration data.

The memory 36 is able to further store at least one piece of control software. This piece of control software is applied by the processor 34 and notably allows control of the operation of the transmitter device 25.

The power supply source 38 is able to electrically power the processor 34, the memory 36 and the unique communication module 37. The power supply source 38 is for example a battery.

The transmitter device 25 is a portable device which for example appears as a casing with dimensions of less than 20 cm. This casing has an ergonomic shape and is adapted so as to be easily displaced by the user.

The method for transferring digital data according to the invention will now be described. In the example as described below, the digital data comprise configuration data.

Thus, according to this example, the transfer method gives the possibility of establishing a secured connection in the assembly 10 of electronic devices.

In order to establish a secured connection of each of the receiving devices 24A and 24B to the computer network 12, the transmitter device 25 exchanges configuration data with the emitting device 14 and with each receiving device 24A or 24B while avoiding the computer network 12. These exchanges are carried out via radioelectric waves.

Initially, the emitting device 14, the transmitter device 25 and the receiving devices 24A and 24B are provided. The computer network 12 is initialized with the emitting device 14.

During a following step, the emitting device 14 generates configuration data relative to this network 12 and allowing the receiving devices 24A and 24B to establish a secured connection to this network 12.

During a following step, a user approaches the transmitter device 25 of the emitting device 14 so that the transmitter device 25 is found in the coverage field of the secondary communication module 30 of the emitting device 14.

When a short range radioelectric connection is established between the emitting device 14 and the transmitter device 25, the emitting device 14 emits radioelectric waves corresponding to the generated configuration data.

The transmitter device 25 thus recovers these configuration data and stores them in the memory 36.

During a following step, the user approaches the transmitter device 25 of one of the receiving devices 24A and 24B, so that the transmitter device 25 is found in the coverage field of the secondary communication module 32A or 32B of this receiving device 24A or 24B.

When a short range radioelectric connection is established between the transmitter device 25 and the receiving device 24A or 24B, the transmitter device emits radioelectric waves corresponding to the configuration data stored in its memory 36.

The receiving device 24A or 24B thus recovers these configuration data and applies them for establishing a secured connection to the computer network 12.

Similarly, a secured connection of the other receiving device 24A or 24B to the network 12 is established when the user approaches the transmitter device 25 of this receiving device 24A or 24B. Of course, when the assembly 10 includes more emitting devices, a secured connection to the computer network of each of them is established in the same way.

The exchange of digital data other than the configuration data between the emitting device 14 and each of the receiving devices 24A or 24B via the transmitter device 25, is carried out in the same way.

According to an exemplary embodiment, each of the emitting device 14 and of the receiving devices 24A and 24B has a casing including a contact area positioned in proximity to the corresponding secondary communication module 30, 32A or 32B.

According to this exemplary embodiment, the secondary communication modules 30, 32A and 32B are able to communicate with the unique communication module 37 when the transmitter device 25 is in contact with the corresponding contact area.

In this exemplary embodiment, the coverage field of each of the secondary communication modules is limited by the corresponding contact area.

Thus, in the method for establishing a secured connection for the assembly 10 according to this exemplary embodiment, the steps consisting of approaching the transmitter device 25 of each of the receiving devices 14, 24A and 24B, comprise the putting of the transmitter device 14 in contact with the corresponding contact area.

The assembly 10 of electronic devices and the method for establishing a secured connection in this assembly includes a certain number of advantages.

In particular, the transmitter device 25 gives the possibility of easily establishing a secured connection of each of the receiving devices 24A and 24B to one or several computer networks 12.

This connection is carried out in a particularly simple way, just by touching or approaching the transmitter device 25 of the corresponding receiving device 24A or 24B. This guarantees a high level of security of the connection and further allows fast connection of a large number of receiving devices 24A and 24B.

Further, the method for establishing such a secured connection does not depend on the type of computer network 12 and allows connection of the receiving devices 24A or 24B to several networks of different types.

Finally, the transmitter device 25 advantageously allows transmission of any type of digital data very safely between an emitting device 14 and one or several receiving devices 24A or 24B while avoiding the main computer network 12.

1. An assembly of electronic devices intended to be connected to at least one computer network comprising:
a device emitting digital data comprising a main communication module with the computer network and a secondary short range radioelectric communication module, the emitting device being able to generate digital data;
at least one receiving device for digital data comprising a main communication module with the computer network and a secondary short range radioelectric communication module, the receiving device being able to use the digital data generated by the emitting device;
wherein the assembly further comprises a portable transmitter device for digital data and comprising:
a processor;
a memory able to store the digital data and at least one piece of control software of the transmitter device, executed by the processor; and
a unique short range radioelectric communication module able to communicate with the secondary communication module of the emitting device for recovering the digital data generated by the emitting device in order to store the digital data in the memory when the transmitter device is in proximity to the emitting device, and with the secondary communication module of the receiving device for transmitting to the receiving device at least some of the digital data stored in the memory when the transmitter device is in proximity to the receiving device;

2. The assembly according to claim 1, wherein the transmitter device further comprises an electric power supply source of the processor, of the memory and of the communication module.

3. The assembly according to claim 1, wherein the unique communication module of the transmitter device and the secondary communication modules of the emitting device and of the receiving device are compatible with a communication protocol compliant with the IEEE 802.15.4 standard.

4. The assembly according to claim 1, wherein the unique communication module of the transmitter device is able to communicate with each of the secondary radioelectric of the transmitter device and of the receiver device from a distance of less than 10 cm.

5. The assembly according to claim 1, wherein each of the unique communication module and of the secondary communication modules is able to define a coverage field in which this communication module is able to communicate with the other communication modules via radioelectric waves.

6. The assembly according to claim 1, wherein:
each of the emitting device and the receiving device includes a contact area; and
the unique communication module of the transmitter device is able to communicate with each of the secondary radioelectric communication modules of the emitting device and of the receiving device while being in contact with the contact area of the emitting device or of the receiving device.

7. The assembly according to claim 1, wherein the main communication modules of the emitting device and of the receiving device are compatible with a communication protocol compliant with the IEEE 802.11 standard.

8. The assembly according to claim 1, wherein the main communication modules of the emitting device and of the receiving device are compatible with a communication protocol of the Program Line Communication (PLC) type.

9. The assembly according to claim 1, wherein the digital data generated by the emitting device comprise configuration data of the computer network allowing the receiving device to establish a secured connection with the computer network.

10. The assembly according to claim 1, wherein:
the emitting device is able to send digital data to the receiving device via the computer network; and
in that the receiving device comprises an acoustic chamber able to emit sound waves from the digital data stemming from the emitting device and delivered by the computer network.

11. A method for transferring digital data in the assembly of electronic devices according to claim 1, wherein the method comprises the steps of:
generating digital data by the emitting device;
recovering digital data with the transmitter device and storing them digital data in the memory after bringing the transmitter device closer to the emitting device, carried out by a user;
recovering digital data with the receiving device after bringing the transmitter device closer to the receiving device, carried out by the user; and
using the digital data with the receiving device having received these digital data.
